(19) United States
(12) Patent Application Publication
(10) Pub. No.: US 2007/0277556 A1
(43) Pub. Date: Dec. 6, 2007

(54) Device and method for melting and/or vitrifying filter gas

(76) Inventors: Heinz-Dieter Forjahn, Kalkar (DE); Johannes Vetter, Meersbusch (DE)

Correspondence Address: Connolly Bove Lodge & Hutz, P O Box 2207, Wilmington, DE, 19899-2207, US

(21) Appl. No.: 10/471,930

(22) PCT Filed: Jun. 18, 2002
(86) PCT No.: PCT/EP02/06712

§ 371 Date: Mar. 1, 2004

(30) Foreign Application Priority Data
Jul. 7, 2001 (DE) 101 33 056.1

(51) Int. Cl. C03B 37/00; F27D 3/00

(52) U.S. Cl. 65/32.1; 373/81

(57) ABSTRACT

When fine filter dust is melted in conventional crucible or induction furnaces, a great deal of dust is generated once again. Compression of the dust is highly complex and is not always possible. According to the invention, the filter dust is collected in a dust-tight top chamber located upstream from the inlet opening of a melting aggregate that is thermally connected to a combustion chamber. The dust particles in the top chamber sink due to the effect of gravity in the melting aggregate and are melted therein. The procedure can be supported by an additional pressure gradient along the melting aggregate. The discharge of dust is largely avoided. The process is also suitable for vitrifying contaminated dust in particular.

The invention relates to a device as well as to a process for melting filter dust.

In order to reduce the volume of waste material that accumulates in the form of filter dust, it is an advantageous procedure to melt the filter dust. When the melting is carried out, the interstices between the individual dust particles are eliminated, thus greatly reducing the total volume. Moreover, the melt, especially that of contaminated types of filter dust, is easier to handle than the dust itself. When fine filter dust is melted in conventional crucible or induction furnaces, however, a great deal of dust is generated once again. For this reason, the filter dust has to be compressed by means of a complex process before the melting procedure. However, in many cases, such compression is not possible.

The objective of the present invention is to create a possibility for melting the filter dust in which the inadvertent escape of filter dust is largely avoided.

This objective is achieved by a device for melting and/or vitrifying filter dust with the features of Patent Claim 1 as well as by a process for melting filter dust with the features of Patent Claim 6.

The invention makes use of the structural principle of a device for melting glass that is known from World Patent WO 97/05440. This device comprises a melting aggregate in the form of a tube that is provided with a gas-tight and fireproof jacket. The material of which the jacket of the tube is made—normally ceramic material—is a function of the raw material to be melted and it is selected in such a way that reactions between the jacket material and the raw material to be melted are kept to a minimum. The upper end of the tube has an inlet opening through which the raw material is fed. An outlet opening that serves to discharge the melt is located in the lower section. The prior-art melting aggregate is concentrically accommodated in an insulated steel casing. The annular space formed between the insulation of the casing and the ceramic tube constitutes the combustion chamber, where the heat needed for the melting process is generated by burning a gas, preferably natural gas. Thus, the material to be melted is fired indirectly. The exhaust gases that are formed during the combustion process are carried away via a gas discharge line that exits from the combustion chamber so that they do not come into contact with the melt or with the raw material.

As a rule, in glass smelting furnaces, there is no risk of dust contamination of the surroundings by the material to be melted. For the invention, however, the strict separation of the melting area and the combustion area, which is characteristic of the above-mentioned subject matter, is especially advantageous since the material to be melted is always separate from the combustion chamber. In this manner, any contamination of the combustion gases by the filter dust to be melted is reliably avoided. Moreover, in the device according to the invention, a top chamber that can be sealed so as to be dust-tight is mounted on the inlet opening of the essentially vertically arranged melting aggregate and this is where the substances in dust form that are to be melted are fed in. Due to the effect of gravity, the dust particles gradually sink into the melting aggregate and are melted. The melt gradually sinks into the lower area of the melting aggregate until it is discharged at the outlet opening. Even light dust particles sink into the melting aggregate after a certain period of time and do not enter the ambient atmosphere.

A preferred embodiment of the invention calls for configuring the melting aggregate conically, whereby the melting aggregate is tapered towards the outlet opening. This embodiment is especially recommended since the volume of the added particles decreases as the melting progresses.

In order to increase the capacity of the device, it is advantageous to configure the top chamber conically or funnel-shaped, whereby it is tapered towards the inlet opening. In this manner, it can receive a larger amount of the material to be melted.

In order to reliably prevent the penetration of dust from the top chamber into the surroundings and in order to allow a continuous operation of the device according to the invention, it is advantageous for a lock arrangement to be installed upstream from the top chamber and for the substances in dust form to be fed in through this arrangement. This lock arrangement can be, for example, an appropriately sealed screw. An especially reliable sealing and consequently preferred lock arrangement is a star feeder lock.

The objective according to the invention is also achieved by a process for melting filter dust with the features of Patent Claim 6.

Therefore, with the process according to the invention, the substances in dust form—which are fed into a melting aggregate and which are melted by heat exposure to a heating element that is thermally connected to the melting aggregate—are fed into a dust-tight top chamber mounted on the melting aggregate before they are melted, where the substances in dust form collect and finally sink into the melting aggregate due to the effect of gravity.

Advantageously, the substances are exposed to a pressure in the top chamber that is greater than the ambient pressure at the outlet opening of the melting aggregate. Thus, along the melting aggregate, a pressure gradient occurs that additionally supports the process of sinking and compression of the particles caused by gravity. The excess pressure can be built up mechanically, for example, by means of a press installed in the top chamber, or by feeding a gas under pressure into the top chamber. Typical pressure values for this range from about 100 mbar to several bar.

In order to avoid undesired chemical reactions, it has proven to be advantageous to fill the top chamber with an inert gas, for example, nitrogen, before or during the addition of the substances. The inert gas can also be used to build up the above-mentioned excess pressure in the top chamber.

It is especially advantageous to simultaneously add glass formers, for example, SiO₂, into the top chamber. The glass former—advantageously likewise present in the form of small particles—mixes with the substances in dust form. Once the melt has hardened, a glass is formed in which the substances are enclosed. This embodiment of the process according to the invention is especially advantageous for disposing of contaminated filter dust.

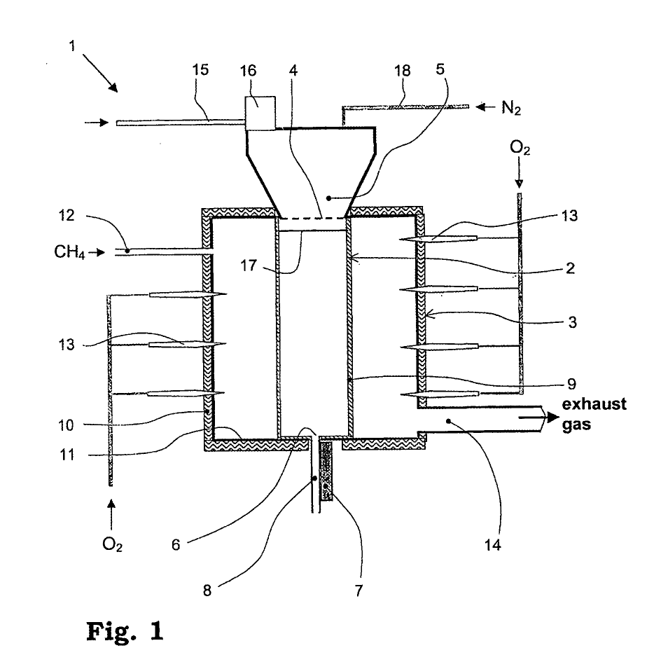

An embodiment of the invention will be explained in greater depth below on the basis of the drawing. The single drawing (FIG. 1) schematically shows a cross section of the structure of a device according to the invention for melting and/or vitrifying filter dust.

The smelting furnace 1 shown in FIG. 1 comprises an essentially tubular, vertically operated melting aggregate 2 that is concentrically accommodated inside an essentially cylindrical combustion chamber 3. At the upper end of the melting aggregate 2, there is an inlet opening 4 for feeding in the raw material that is to be melted. Upstream from the inlet opening 4, there is a funnel-shaped top chamber 5 for receiving the substances in dust form that are to be melted. The top chamber 5 is sealed dust-tight and pressure-tight vis-à-vis the ambient atmosphere. New substances are continuously fed from the top chamber 5 into the melting aggregate 2 without causing any lasting disturbance of the thermal or chemical conditions inside the melting aggregate 2 due to the penetration of outside air or the like.

At its lower section, the melting aggregate 2 has an outlet opening 6 for discharging the melt that is being formed in the melting aggregate 2. At the outlet opening 6, there is an outlet nozzle 8 made of a material that conducts heat well and that is chemically inert such as, for instance, platinum, which is thermally connected to a heating element 7. The heating of the outlet nozzle 8 ensures that the material present inside the outlet nozzle 8 is in the molten state, that is to say, flowable state.

The wall 9 of the melting aggregate 2 consists of a heat-resistant and gas-tight material, for instance, a ceramic or metallic material. The material used here depends on the type and composition of the substances to be melted. In particular, the material of the wall 9 should be such that, to the greatest extent possible, it does not react with the melt that is formed inside the melting aggregate 2.

A fuel feed line 12 for gaseous fuel, for example, natural gas as well as a plurality of injection nozzles 13 for oxygen pass through the wall 11 of the combustion chamber 3, which is provided with an insulating layer 10. The injection nozzles 13 are arranged in a circular pattern at regular angular distances and in several rows at intervals one above the other. A gas discharge line 14 is provided in order to discharge the exhaust gas formed during the combustion. The fuel fed in via the fuel feed line 12 is burned with the oxygen that is fed in via the injection nozzles 13. In this process, the quantity of oxygen fed in via the injection nozzles 13 in one row can be set separately, whereby all in all, an oxygen amount that corresponds to the stoichiometric ratios is fed in. This approach makes it possible to set a temperature profile throughout the melting aggregate 2 that is advantageous for the melting process.

During the operation of the smelting furnace 1, the substances in dust form that are to be melted and/or vitrified are fed into the top chamber 5 via the feed line 15 and via a lock arrangement 14. The lock arrangement 16 is preferably a star feeder lock, which can be sealed off very well. If the substances in dust form are to be vitrified, then a glass former is also added, either likewise via the feed line 15 or else via a separate opening (not shown here) that has a dust-tight lock. The substances in dust form fed into the top chamber 5 sink to the inlet opening 4 after a certain period of time, thus reaching the melting aggregate 2, where they are melted by the heat generated in the combustion chamber 3, up to the height of a melting mirror 17. Above the melting mirror, the substances are still in solid form, i.e. in dust form. The dust-tight sealing of the top chamber as well as the physical separation of the melting section in the melting aggregate 2 from the combustion chamber 3 prevent the inadvertent escape of dust from the device 1. In order to accelerate the melting process, the top chamber 4 is in flow-connection via a pressure line 18 with a compressed gas reservoir for an inert gas, for example, nitrogen. By feeding in the inert gas that is under pressure, an excess pressure—as compared to the ambient pressure—is generated inside the top chamber 4. Thus, along the melting aggregate 2, an additional pressure gradient of 100 to 3000 mbar is created that, first of all, compresses the still solid dust particles together, and secondly, increases the throughput rate through the melting aggregate 2 of the material to be melted. The melted material emerges at the outlet nozzle 6 in liquid form, whereby the heating element 7 prevents premature hardening inside the outlet nozzle. After the melted material has hardened, it has a much smaller volume than when it was in its dust form and it can more easily be disposed of or conveyed away for reutilization. If a glass former was admixed to the substances in dust form, then once the melt has hardened, a glass is formed in which the substances are enclosed.

The smelting furnace 1 is compact and can be used in a flexible manner, while also standing out for its high cost-effectiveness in comparison to conventional crucible furnaces. By separating the melting and combustion chambers, a simple and inexpensive insulating compound can be selected as the insulating layer 10 of the combustion chamber 3. Since the exhaust gas from the combustion chamber 3 does not come into contact with the melt in the melting aggregate 2, when natural gas is burned, almost 100% of said exhaust gas consists of carbon dioxide and water vapor. The smelting furnace 1 can be operated continuously as well as in batch operation.

### LIST OF REFERENCE NUMERALS

1 smelting furnace
2 melting aggregate
3 combustion chamber
4 inlet opening
5 top chamber
6 outlet opening
7 heating element
8 outlet nozzle
9 wall (of the melting aggregate)
10 insulating layer
11 wall (of the combustion chamber)
12 fuel feed line
13 injection nozzle
14 gas discharge line
15 feed line
16 lock arrangement
17 melting mirror
18 pressure line

1-9. (canceled)

10. A device for melting and/or vitrifying filter dust in which a melting aggregate that is thermally connected to a combustion chamber and that has an inlet opening for feeding components that are to be melted and that has an outlet opening for the melted material, whereby a top chamber that can be sealed so as to be dust-tight vis-à-vis the outside atmosphere is mounted on the inlet opening of the essentially vertically positioned melting aggregate.

11. The device according to claim 10, characterized in that the melting aggregate is conical and tapered towards the outlet opening.

12. The device according to claim 11, characterized in that the top chamber is conical or funnel-shaped, whereby it is tapered towards the inlet opening.

13. The device according to claim 12, characterized in that a lock arrangement is installed upstream from the top chamber.

14. The device according to claim 10, characterized in that a lock arrangement is installed upstream from the top chamber.

15. The device according to claim 14, characterized in that a star feeder lock is provided as the lock arrangement.

16. The device according to claim 10, characterized in that the top chamber is conical or funnel-shaped, whereby it is tapered towards the inlet opening.

17. A process for melting filter dust in which substances in dust form are fed into a melting aggregate, the substances are melted by heat exposure to a heating element, that is thermally connected to the melting aggregate, and the substances are fed in liquid form to an outlet opening for purposes of further processing, whereby the substances in dust form are fed into a dust-tight top chamber mounted on the melting aggregate before the substances are melted in the melting aggregate, from where the substances sink into the melting aggregate due to the effect of gravity.

18. The process according to claim 17, characterized in that the substances are exposed to a pressure in the top chamber that is greater than the ambient pressure at the outlet opening of the melting aggregate.

19. The process according to claim 18, characterized in that the top chamber is filled with an inert gas before or during the addition of the substances in dust form.

20. The process according to claim 19, characterized in that the inert gas is nitrogen.

21. The process according to claim 19, characterized in that glass formers, for example, SiO₂, are added into the top chamber for purposes of vitrifying the substances that are fed in.

22. The process according to claim 21, characterized in that glass formers are SiO₂.

23. The process according to claim 17, characterized in that the top chamber is filled with an inert gas before or during the addition of the substances in dust form.

24. The process according to claim 17, characterized in that glass formers, for example, SiO₂, are added into the top chamber for purposes of vitrifying the substances that are fed in.

25. The process according to claim 17, characterized in that the heating element is a combustion chamber.

26. The process according to claim 17, characterized in that the heating element is an electric heater.
